(19) United States
(12) Patent Application Publication
(10) Pub. No.: US 2008/0069121 A1
(43) Pub. Date: Mar. 20, 2008

(54) Gateway For A Local Network System

(75) Inventors: Anthony Adamson, London (GB); Daniel A. Van Den Heever, Cambridge (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,457

(22) PCT Filed: Jun. 7, 2005
(86) PCT No.: PCT/IB05/51842

§ 371 Date: Dec. 12, 2006

(30) Foreign Application Priority Data
Jun. 15, 2004 (GB) 0413334.4

(51) Int. Cl. H04L 12/28

(52) U.S. Cl. 370/401

(57) ABSTRACT

A gateway (150) is connected to local networks (40, 45) of target devices (20-23). The gateway (150) has an event handling function (162) which stores events (173) which may occur and, for each event, commands for controlling the target devices (20-23). A remote server (50) supports an application (130) which configures the event handling function (162) for control of the target devices as well as directly communicating with target devices (20-23). The gateway (150) continues to allow operation of target devices (20-23) if communication with the remote server (50) is interrupted. The invention can be used as an enhancement of the OSGi Virtual Gateway Model, with an OSGi Java application (130) being supported by a Java Virtual Machine on the server (50). The event handling function (162) can be achieved by executing an application written in the native code of the gateway (150).

This invention relates to a gateway for a local networking system, such as a system for control of appliances within a home environment.

There is considerable interest in networking appliances within the home environment and in remote control of appliances, either from within a home or from a location remote from the home.

A variety of protocols have been developed in recent years for use in controlling appliances, such as the European Home Systems (EHS) protocol, ZigBee, X10 and the Universal Plug and Play Protocol (UPnP).

In an attempt to create a coherent framework for networking, the Open Services Gateway Initiative (OSGi) has proposed an open, managed framework that aims to allow applications (or ‘services’) to be deployed, installed and run in local networks such as homes, cars and small offices. The heart of the local network is a gateway that supports an OSGi Service Platform which executes the OSGi framework. The Service Platform is based around a Java Virtual Machine (JVM). The latest published version of the OSGi Service Platform Specification is version 3, March 2003 from ‘The OSGi Alliance’ and more information about OSGi can be found at www.osgi.org.

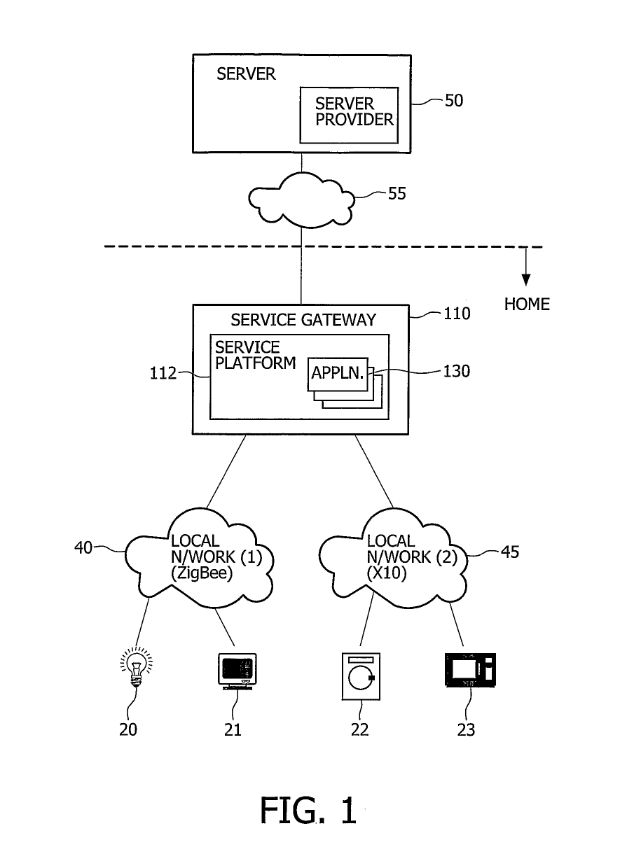

The OSGi has defined both a Residential Gateway Service Model and a Virtual Gateway Model. A simplified instance of the Residential Gateway Service Model is shown in FIG. 1. The Service Platform 112, upon which the user applications (services) 130 are executed, is located at the client, such as a home of a user. Target devices 20-23 which are to be controlled are connected to the gateway 110 by local networks 40, 45, which can each be based on different networking protocols, such as ZigBee and X10, may also differ in their physical connections. Gateway 110 is connected to a remote server 50 across a network 55. The remote server 50 can initially supply the applications 130 to the service platform 112, provide service operations support and other functions. This model requires a Java Virtual Machine (JVM) at the client, which can be an onerous requirement for clients who only wish to support simple applications, such as on/off instructions for appliances, thermostats and lighting.

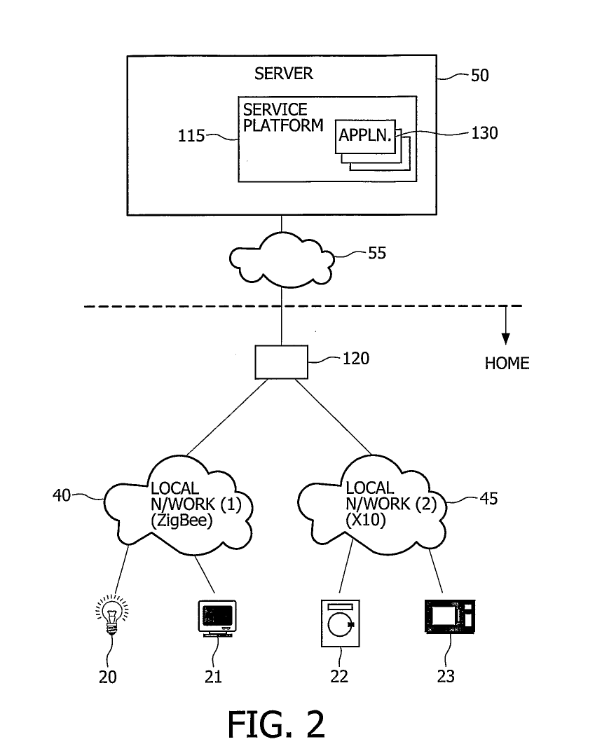

The OSGi Virtual Gateway Model is shown in FIG. 2. Here, the Service Platform 115, upon which applications 130 are executed, is located at server 50, remote from the client, and is connected to the client across a network 55. In this model the client does not require a Java Virtual Machine at their premises as the gateway 120 acts as a simple interface between the server 50 and local networks 40, 45. Messages received from the service platform 115 are forwarded to the local networks 40, 45 and messages received from devices 20-23 in the local networks 40, 45 are sent across the network 55 to the service platform 115. A disadvantage with the Virtual Gateway Model is that successful operation of the client's network relies upon a continuous communication link between the remote server 50 and gateway 120, since all processing occurs at the service platform 115 at the remote server 50. If communication is interrupted, or if the service platform 115 is out of operation, such as for maintenance or because of a fault, it is not possible to control devices 20-23 at the client. The consequences of this may be that the user cannot operate their devices 20-23 within the home, or that security or monitoring applications cannot be performed.

The present invention seeks to provide an alternative arrangement for controlling devices within a local network.

Accordingly, a first aspect of the present invention provides a gateway for controlling a local network of target devices comprising:

an event handling function which stores events which may occur and, for each event, commands for controlling the target devices;

a server interface for communicating with a remote server, the remote server supporting an application, the server interface receiving commands from the application which configure the event handling function for control of the target devices; and,

an interface for communicating with the target devices;

wherein the gateway is operable to allow continued operation of target devices if communication with the remote server is interrupted.

The gateway and target devices effectively operate as a ‘survival cell’ in the event of an interruption to communication with the remote server. This can be particularly important with critical applications such as monitoring of medical equipment and home security.

The invention can be used as an enhancement of the OSGi Virtual Gateway Model, with an OSGi Java application being supported by a Java Virtual Machine on the server. However, rather than relying entirely on a communication link between target devices and the application for device control, the gateway can itself provide control of target devices if communication with the remote application is interrupted. The functions of the gateway can be provided by a processing platform which is considerably less powerful, and therefore cheaper, than that required to support a JVM. Preferably, the event handling function is achieved by executing an application written in the native code of the gateway.

It is preferred that one common protocol is used within the gateway, and preferably also for the interface between the gateway and the server. A particularly advantageous protocol is the Home Uniform Control Language (HUCL). This is a lightweight protocol which can minimise the demands of a host device, such as processing power and power consumption. Where HUCL is used to directly communicate with target devices, the target devices also achieve similar benefits of reduced processing and power consumption. The use of a common protocol provides a standard interface for all devices.

A further aspect of the present invention provides a system for controlling target devices comprising a server and at least one client, wherein the client comprises:

a gateway having:
an event handling function which stores events which may occur and, for each event, commands for controlling the target devices;
a server interface for communicating with the server; and,
an interface for communicating with the target devices;
   and the server supports an application which configures the event handling function for control of the target devices, the gateway being operable to allow continued operation of target devices if communication between the gateway and the server is interrupted.

The functionality described here can be implemented in software, hardware or a combination of these. The invention can be implemented by means of hardware comprising several distinct elements, and by means of a suitably programmed computer.

Accordingly, another aspect of the invention provides instructions for a gateway for controlling a local network of target devices, the instructions causing a processor of the gateway to support:

an event handling function which stores events which may occur and, for each event, commands for controlling the target devices;

a server interface for communicating with a remote server, the remote server supporting an application, the server interface receiving commands from the application which configure the event handling function for control of the target devices; and,

an interface for communicating with the target devices;

wherein the gateway is operable to allow continued operation of target devices if communication with the remote server is interrupted.

It will be appreciated that software may be installed on the gateway at any point during the life of the equipment. The software may be stored on an electronic memory device, hard disk, optical disk or other machine-readable storage medium. The software may be delivered as a computer program product on a machine-readable carrier or it may be downloaded directly to the gateway via a network connection.

Embodiments of the present invention will now be described, by way of example only, with reference to the accompanying drawings, in which:

FIG. 1 shows a simplified OSGi Residential Gateway Service Model;

FIG. 2 shows a simplified OSGi Virtual Gateway Model;

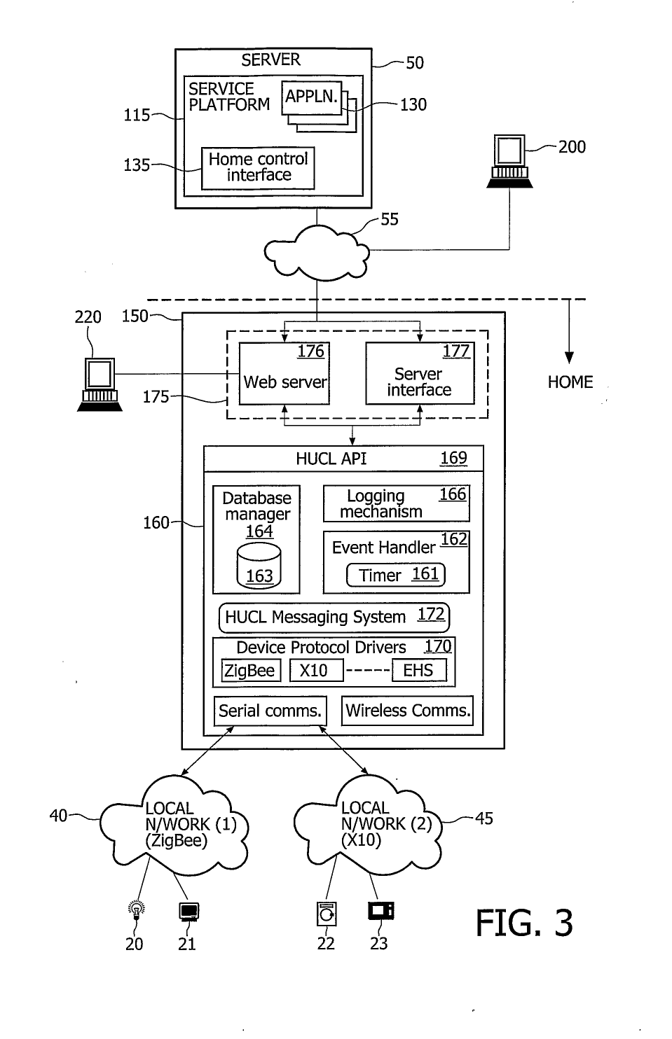

FIG. 3 shows a gateway in accordance with an embodiment of the invention;

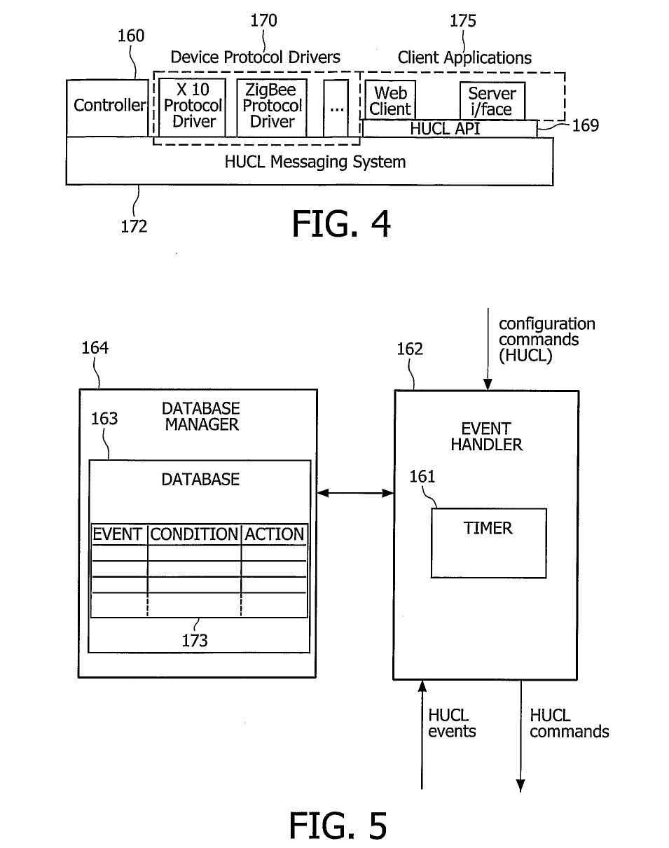

FIG. 4 shows a messaging system used in the gateway of FIG. 3;

FIG. 5 shows the event handler and database used within the gateway of FIG. 3;

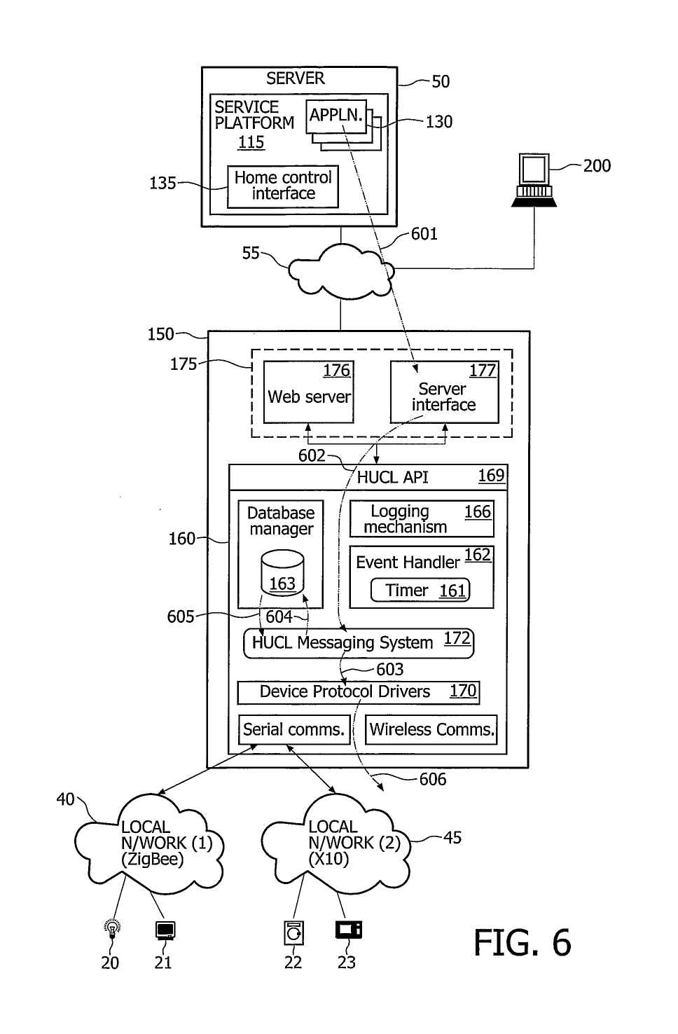

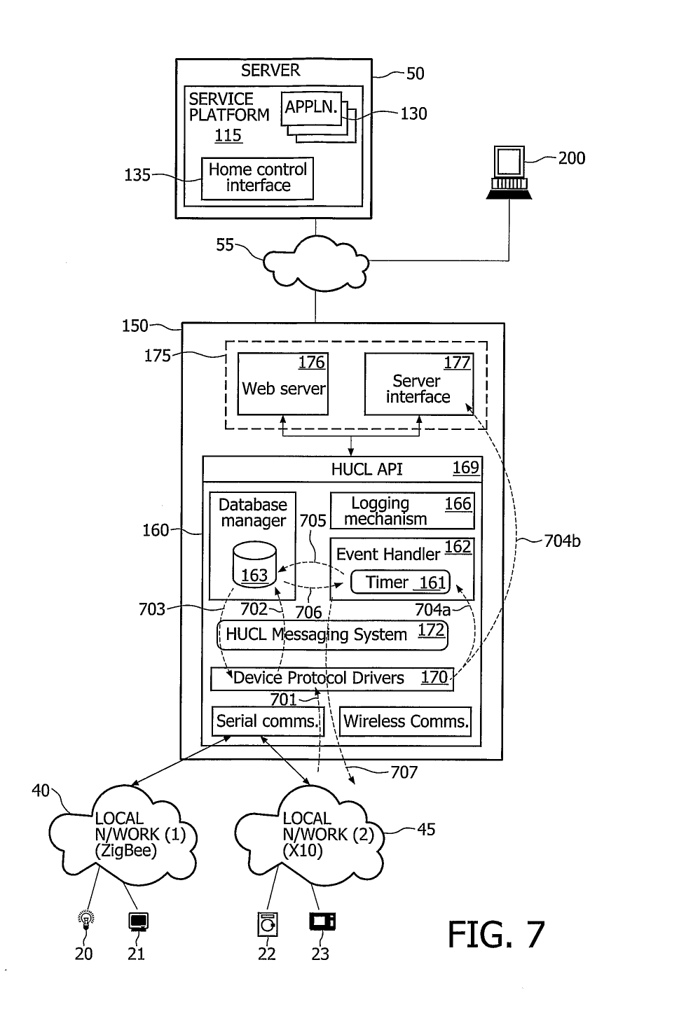

FIGS. 6 and 7 show message flows within the gateway of FIG. 3;

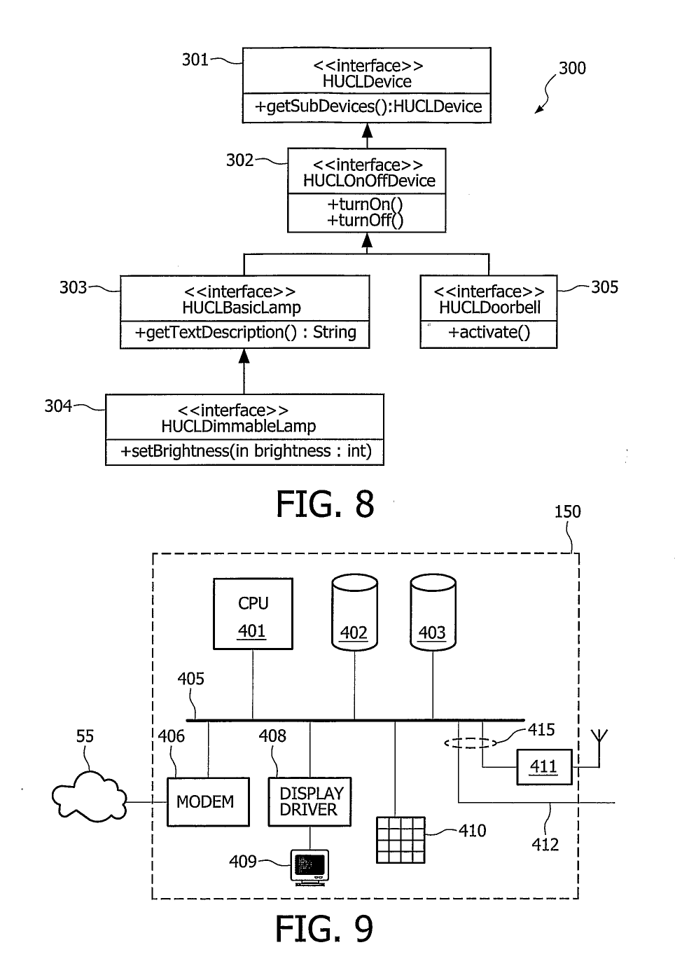

FIG. 8 shows a device service hierarchy; and

FIG. 9 shows hardware for implementing the gateway of FIG. 3.

FIG. 3 shows the overall architecture of a gateway 150 in accordance with an embodiment of the invention. The gateway 150 is located at the premises where a local network is required. The gateway 150 is connected to a plurality of target devices 20-23, which may include appliances, lights, light switches, thermostats and so on. The overall collection of target devices 20-23 can operate according to different networking protocols. In this example, target devices 20, 21 are part of a network 40 that operates according to the ZigBee protocol. The physical network layer to each hardware device 20-23 may be wireless (e.g. IEEE 802.15.4 in the case of ZigBee, IEEE 802.11, Bluetooth™ or similar) or wired (e.g. serial bus, Ethernet cabling, electrical cabling (X10)). The gateway 150 also connects to a network 55 that provides a communication link with a remote server 50. Server 50 supports one or more applications 130 which can communicate with a server interface 177 on the gateway 150. Server interface 177, which is a client application of the gateway 150, either interacts directly with the HUCL messaging system 172 or updates a database 163 with triggered/timed event information.

The gateway 150 includes a controller 160 that supports functionality for control of devices 20-23. In effect, controller 160 together with the local networks 40, 45 and devices 20-23 form a ‘survival cell’ which can allow devices 20-23 at the client to operate even if communication with the remote server 50 is interrupted. Controller 160 operates according to a common protocol, which in a preferred embodiment is the Home Uniform Control Language (HUCL). The main features of HUCL are described in International patent applications: WO 2004/015926, WO 2004/015927, WO 2004/015928 and WO 2004/015929. A set of device protocol drivers 170 interface (or bridge) between the protocol used on networks 40, 45 and the common language (HUCL) used by the controller 160. A HUCL messaging system 172 distributes messages between the protocol drivers 170, the functional units within the controller 160, and the application programming interface (API) 169, as shown in FIG. 4. HUCL is a lightweight protocol that makes low demands on host equipment, using compressed XML messages. HUCL also provides a basic and extended device description, which can reduce messaging overheads between functional units within the controller 160. The HUCL API 169 interfaces to applications 175 executed locally.

Controller 160 operates continuously, listening to events from the networks 40, 45 and then checking database 163 to see if any action needs to be taken in response to events. If so, the controller takes the necessary actions (called a triggered event). If a timer expires, this also initiates an event (called a timed event). If the server interface 177 receives a message from the server 50, this either updates the table of events 173 (FIG. 5) stored in the database 163 (e.g. a message from application 130 says “When the light switch is pressed, turn on light A”, or “At 8 pm, turn on the washing machine”), or talks to the HUCL messaging system to issue a command to a target device such as “turn light A on now”. Remote applications 130 only communicate with the server interface 177.

If communication between the gateway 150 and server 50 is interrupted, then controller 160 continues to operate and continues to respond to triggered events and timed events that have previously been stored in database 163. Certain, limited, features cannot be supported during a period of interruption. If the action required by a triggered event involves communication with server 50, then this cannot be achieved. Also, during a period of interruption gateway 150 cannot be accessed by server 50 or by any remote terminals 200 to modify operation of the controller 160, or to issue commands directly to the target devices (via server interface 177 and the HUCL messaging system 172). As described below, a local web server 176 can also be provided for allowing gateway 150 to be locally configured during periods of interruption.

On the server 50, there is a Home Control Interface 135 which will send/receive HUCL messages across the network 55 to the server interface 177. The server interface 177 then communicates with the controller 160, which in turn communicates with the various devices 20-23 on the local networks 40, 45 via the protocol drivers 170. These convert HUCL messages into the network specific protocol and vice versa for upward communication. Database 163 stores information (a software representation called a device service) about each target device in networks 40, 45. It is preferred that this information is stored as a HUCL composite device. One HUCL composite device is registered with the OSGi framework supported by the service platform 115 on server 50, and the composite device in turn represents the set of target devices 20-23 in networks 40, 45. The concept of a HUCL composite device is described in International Patent Application WO 2004/015927. The use of a HUCL composite device makes the system more scalable as it can more easily cope with a large number of target devices 20-23. The main components of the API 169 are the commands SendHUCLMsg( ) and ReceiveHUCLMsg( ) and some additional addressing information to identify which sub-device of the HUCL composite device is identified in each message. The use of a HUCL composite device allows a simple interface between the gateway 150 and the server 50. In accordance with a feature of the HUCL protocol, as described in International Patent Application WO 2004/015956, an application 130 can query the HUCL composite device for a simple description and an extended description of each target device. Server 50 can operate in a manner in which it requests information about target devices 20-23 as it is needed, or it can store information locally. Storing information at the server 50 can be useful in the event that it is necessary to reconfigure the gateway 150.

The controller 160 includes an event handler 162, logging mechanism 166 and database manager 164. Database manager 164 controls storage and retrieval of data from the local database 163. Event handler 162 has two main aspects:
Event configuration, in which possible triggers, conditions and actions are presented and corresponding HUCL commands are constructed and stored in database 163 according to a user's requirements, or as configured by the remote application 130. Events can be set by any local client (i.e. server interface 177 or local Web Server 176). Remote applications 130 communicate with the server interface 177 to set, update or cancel events.
HUCL Device Event handling, in which the controller 160 subscribes to receive all HUCL Device Events generated by the device protocols, and checks if any triggers a stored local Event. If a trigger is detected the condition (if any) is checked, and the pre-configured HUCL command actions dispatched. Stored events are configured by the client applications 175 or remote applications 130, using calls to the Event Handler 162 to set up triggers, conditions and actions. The Device Events are events generated by target devices, such as “washing machine has finished”, or “light switch pressed” Stored events are associated with the occurrence of particular device events, e.g. “When a passive infrared (PIR) detector senses movement within a room, sound burglar alarm”. The process of monitoring for the occurrence of local events, and acting upon them, continues in the survival cell autonomously in the event of an interruption of the link to server 50. A list is maintained in the database of those clients who subscribe to particular Device Events.
   As shown in FIG. 5, the event handler 162 stores local event data 173 in the database 163. Stored events can be triggered by HUCL Device Events from Device Protocol Drivers (e.g. a light switch being turned on or a thermostat reaching a particular temperature), or by the expiration of a timer 161 at the event handler 162 (e.g. in response to stored event data to turn a light on at 8 pm, or to turn a heater off after a period of 30 mins.) The Event handler 162 stores, for each event, any conditions that apply to that event (e.g. an actual time or an elapsed time which can be monitored by timer function 161) and a set of actions that must be performed in response to that event (e.g. turn security light on.) Other possible conditions that may apply are, e.g. “only turn on lights at 8 pm when I'm on holiday”, or a condition which is dependent on the state of devices, e.g. “only turn on outside light if the light meter says it's dark”.

The logging mechanism 166 allows the system to record data, such as significant events and errors, by writing data to a log file. This can be used to record data about the system.

The local web server 176 is provided at the gateway 150 as a backup to allow local configuration from a web browser located on the same local network as 150. This is also linked to the controller 160. The web page to interact with the system could be configured to first view the local web server 176. This would then test the remote connection and redirect to user if available. If not, it would default to the local web pages.

The server interface 177 can interface to the database 163 and retrieve a list of current events and send this to application 130 to show to the user. If communication with the server 50 is interrupted then the local webserver 176 can also do this.

Example message flows for two scenarios will now be described with reference to FIGS. 6 and 7. Firstly, FIG. 6 shows the message flows when a command is sent from an application 130 to a target device in the network. The initiation of the command being sent from application 130 can originate from a remote user application, for example a web browser, running on terminal 200, talking to application 130 directly, or through a web server on 50 which then talks to application 130. At step 601, application 130 sends a HUCL message across network 55, via the Home Control Interface 135, to the server interface 177. The interface 177 then generates a message 602 describing the device command. At step 603, the HUCL messaging system 172 delivers the command message to the device protocol driver 170. Optionally, at step 604, the device protocol driver 170 requests stored information from the database 163 via the database API and at step 605 the response is returned as a HUCL message. In general, every network 40, 45 has a different way of addressing devices and the database lookup at steps 604, 605 is one way of retrieving network specific information. On an X10 network, devices are referred to by their house and device code, while HUCL only has a single device ID. On a ZigBee network there is a network and device address. In an alternative method, all network information is cached within the Device Protocol Drivers 170. At step 606 the device protocol driver 170 converts the command into a message which is sent to a particular target device 20-23 on the target networks 40, 45.

In an alternative to the above (but not shown in FIG. 6), the remote application 130 sends a message across network 55 which is intended to configure an event in database 163. Steps 601 and 602 are the same as before. However, at step 603 a HUCL message is sent to the event handler 162 which includes details of the event that is to be stored (shown as a ‘configuration command’ in FIG. 5). The event handler 162 then updates the database 163 with this information. The event can be a triggered event or a timed event.

As a result of a target device being controlled, in the manner described above, or in response to a user interacting with a target device (e.g. turning a light switch on), a new device event may be generated. This will cause the sequence of messages shown in FIG. 7. In FIG. 7, a device protocol event is sent from a protocol driver. At step 701, activity is detected by hardware on the network 45 and is communicated via low-level drivers, such as Linux drivers. A device protocol driver 170 becomes aware of activity on the target network 45. In optional steps 702, 703 HUCL messages transfer data to/from database 163 which include device protocol event subscribers and possibly the current and updated device state. Each operation includes a request 702 and response 703. At steps 704a, 704b the device protocol driver 170 generates a HUCL event message representing a device protocol event and sends it via the HUCL messaging system 172 to all subscribed targets. The event handler 162 subscribes to all device events and so will always be in a position to respond to events within the network. Client applications 175 may also subscribe to the device events, including the server interface 177. At step 705 the event handler 162 queries the event data 173 held in database 163 to determine whether there are any conditions associated with the event, and returns data at step 706. Event handler 162 can then determine whether the event conditions (if any) have been met and, if so, issue the HUCL commands associated with that event at step 707. It will be noted that this operation can occur even communication with the remote server is interrupted.

One of the features of this architecture which allows the controller 160 to provide a useful level of functionality with only limited processing and storage capabilities is the device type hierarchy of HUCL. This will be described with reference to FIG. 8. HUCL has a hierarchical arrangement of device services. FIG. 8 shows an example hierarchy of device services 300, with a general HUCL device 301 at the top. The function ‘getSubDevices( )’ returns the device service of the next layer of sub-devices, if any are present. Moving down the hierarchy, device services have an increased level of detail/functionality. Thus, device service 302 represents a target device that has the ability to turn on/off. Moving down the left-hand side of the hierarchy, device service 303 defines a basic lamp, which inherits the feature of the class above it, i.e. it can also turn on/off. Device service 304 defines a dimmable lamp, i.e. a lamp with the function of being set to a particular brightness value within a range of possible values. Device service 304 also inherits the features of 302 and 303 above it, i.e. it is a lamp and it can turn on/off. Moving down the right hand side of the hierarchy, device service 305 defines a door bell which inherits the features of a HUCL on/off device 302. In this example, if an application (e.g. application 130) does not know how to talk to a device of the type “HUCLDimmableLamp”, it can still use the “HUCLBasicLamp” definition or even the basic “HUCLDevice” definition with the certainty that the device service will understand that functionality. Effectively, HUCL allows an application to ‘walk up the hierarchy tree’, and if an application finds that it does not recognise a device type (e.g. dimmable-lamp) then it checks the other device types listed in the device type list provided as part of the device service. Similarly, an application which has the ability to turn something on/off can drive a lamp, door bell or any other type of device which is capable of being turned on/off since the device services representing all target devices will follow the hierarchy. A target device is represented at every level above its ‘lowest’, most accurate representation. This approach allows devices to be manipulated to their fullest extent, even in situations where the developer does not know the full details of a particular device. This allows manufacturers of target devices to provide products which will interoperate to a certain level, but also to add unique features to their products which will differentiate them from other products.

The gateway 150 described above can be implemented on a variety of processing platforms, such as a general purpose PC or a dedicated processing unit, although the architecture is particularly suited to processing platforms with modest processing power, since there is no need to support a Java Virtual Machine and an OSGi Java application. FIG. 9 shows the main components of the processing platform. A central processing unit 401 executes software, as previously described, to support the controller 160 and client applications 175. Typically, the central processing unit 401 has a native operating system (e.g. based on Linux). Non-volatile memory 402 and volatile memory 403, such as a hard disk, store the operating software used by the processing unit 401. A modem 406, such as a broadband ADSL or cable modem, connects to a network 55 which joins the gateway 150 to a remote server (50, FIG. 3) on which applications are supported. The broadband modem 406 may be external to the gateway 150. Control messages to/from controlled devices are carried by local network connections 415, which use a combination of wired 412 and wireless 411 technologies. Appropriate hardware may be provided to support the particular local network such as: a local area network card; a wireless, infrared or power line (for example X10) modem. User inputs can be provided directly to the gateway by input devices 410 such as a keypad, keyboard, mouse or tablet. Alternatively, user inputs may be received from a remote control unit that is locally networked with the gateway 150, or from terminal 200 connected to network 55. As an example, if a user is away from their home and wishes to send instructions to the gateway to control appliances within the home, a user will interact with a remote terminal 200 and send instructions, via a network connection to the gateway 150. An output may be directly presented to a user via a display driver 408 and display 409, to a local control unit 220 or to a remote terminal 200. A bus 405, or combination of buses of different types, connect the above units.

A wide variety of applications 130 can be executed on the remote server 50. Examples of these include: home control, such as simulating occupancy of a building by turning lamps on and off at predetermined times, control of heating and ventilation, programming a video recorder; control of entertainment and consumer electronics devices; remote monitoring of security of a building or the health of an occupant of a building; remote fault reporting/diagnosis.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim. Where the system/device/apparatus claims recite several means, several of these means can be embodied by one and the same item of hardware.

In the description above, and with reference to the Figures, there is described a gateway 150 which is connected to local networks 40, 45 of target devices 20-23. The gateway 150 has an event handling function 162 which stores events 173 which may occur and, for each event, commands for controlling the target devices 20-23. A remote server 50 supports an application 130 which configures the event handling function 162 for control of the target devices as well as directly communicating with target devices 20-23. The gateway 150 continues to allow operation of target devices 20-23 if communication with the remote server 50 is interrupted. The invention can be used as an enhancement of the OSGi Virtual Gateway Model, with an OSGi Java application 130 being supported by a Java Virtual Machine on the server 50. The event handling function 162 can be achieved by executing an application written in the native code of the gateway 150.

1. A gateway (150) for controlling a local network (40, 45) of target devices (20-23) comprising:
an event handling function (162) which stores events (173) which may occur and, for each event, commands for controlling the target devices (20-23);
a server interface (177) for communicating with a remote server (50), the remote server (50) supporting an application (130), the server interface (177) receiving commands from the application (130) which configure the event handling function (162) for control of the target devices (20-23); and,
an interface (170) for communicating with the target devices (20-23);
wherein the gateway (150) is operable to allow continued operation of target devices (20-23) if communication with the remote server (50) is interrupted.

2. A gateway according to claim 1 wherein the application (130) supported by the remote server (50) is written in a first language and the event handling function (162) is written in a second, lower level, language.

3. A gateway according to claim 1 wherein the application (130) supported by the remote server (50) is a Java application and the event handling function (162) is implemented using the native code of the gateway (150).

4. A gateway according to claim 1 wherein the application (130) supported by the remote server is an Open Services Gateway Initiative (OSGi) application.

5. A gateway according to claim 1 wherein the server interface (177) is further operable to receive commands from the application (130) which are passed to the target devices (20-23).

6. A gateway according to claim 1 wherein at least some of the stored events (173) have conditions associated with them and the event handling function (162) is arranged to determine whether the associated conditions are met.

7. A gateway according to claim 1 wherein the event handling function (162) further comprises a timer (171) for handling time-dependent events.

8. A gateway according to claim 1 wherein the event handling function (162) is responsive to events triggered by operation of the target devices (20-23).

9. A gateway according to claim 1 wherein the event handling function (162) stores events which are programmed to occur at a predetermined time.

10. A gateway according to claim 1 further comprising an interface (176) for locally configuring the event handling function (162) when communication with the remote server (50) is interrupted.

11. A gateway according to claim 1 wherein the target device interface (170) comprises at least one driver for converting between a protocol used by the target devices and a common protocol used by the gateway.

12. A gateway according to claim 11 wherein the common protocol is also used to interface with the application (130).

13. A gateway according to claim 11 wherein the common language has a common hierarchical structure of device types, in which an entity representing a device type lower in the hierarchy inherits the properties of device types higher in the hierarchy, whereby to present a consistent API to applications.

14. A gateway according to claim 11 wherein the common language uses messages in an XML format.

15. A gateway according to claim 11 wherein the common protocol is the Home Uniform Control Language (HUCL).

16. A gateway according to claim 1 in the form of a residential gateway (150) for controlling appliances (20-23).

17. A system for controlling target devices (20-23) comprising a server (50) and at least one client, wherein the client comprises:
a gateway (150) having:
an event handling function (162) which stores events (173) which may occur and, for each event, commands for controlling the target devices (20-23);
a server interface (177) for communicating with the server (50); and,
an interface (170) for communicating with the target devices (20-23);
and the server (50) supports an application (130) which configures the event handling function (162) for control of the target devices (20-23), the gateway (150) being operable to allow continued operation of target devices (20-23) if communication between the gateway (150) and the server (50) is interrupted.

18. A system according to claim 17 wherein the application (130) supported by the server is written in a first language and the event handling function (162) is written in a second, lower level, language.

19. A system according to claim 17 wherein the application (130) supported by the server is a Java application and the event handling function (162) is implemented using the native code of the gateway.

20. A system according to claim 17 wherein the application (130) supported by the server is an Open Services Gateway Initiative (OSGi) application.

21. A system according to claim 1 wherein the target device interface (170) comprises at least one driver for converting between a protocol used by the target devices (20-23) and a common protocol used by the gateway (150).

22. A system according to claim 21 wherein the common protocol is also used to interface with the application (130).

23. Instructions for a gateway (150) for controlling a local network (40, 45) of target devices (20-23) as claimed in claim 1, the instructions causing a processor (401) of the gateway to support:
an event handling function (162) which stores events (173) which may occur and, for each event, commands for controlling the target devices (20-23);
a server interface (177) for communicating with a remote server (50), the remote server supporting an application, the server interface (177) receiving commands from the application (130) which configure the event handling function (162) for control of the target devices (20-23); and,
an interface (170) for communicating with the target devices (20-23);
wherein the gateway (150) is operable to allow continued operation of target devices (20-23) if communication with the remote server (50) is interrupted.

24. A gateway, system or instructions for a gateway substantially as described herein with reference to and as shown in the accompanying drawings.
